(19) United States
(12) Patent Application Publication
(10) Pub. No.: US 2025/0229468 A1
(43) Pub. Date: Jul. 17, 2025

(54) A SYSTEM AND A METHOD FOR INJECTION MOULDING

(71) Applicant: LEDIL OY, Salo (FI)

(72) Inventor: Petri MIKKOLA, Salo (FI)

(21) Appl. No.: 18/853,692

(22) PCT Filed: Feb. 10, 2023
(86) PCT No.: PCT/FI2023/050082

§ 371 Date: Oct. 2, 2024

(30) Foreign Application Priority Data
Apr. 5, 2022 (FI) 20225291

(51) Int. Cl. B29C 45/00; B29L 11/00

(52) U.S. Cl. CPC B29C 45/0003; B29L 2011/00

(57) ABSTRACT

The present disclosure relates to systems and methods of manufacturing elongated products such as optical devices by injection moulding, wherein length of the product can be longer than the length of the cavity of the mould wherein the product is manufactured.

### FIELD

The disclosure relates to systems and methods for manufacturing elongated products such as optical devices by injection moulding, in particular to systems and methods wherein length of an elongated product can be longer than the mould wherein it is moulded.

### BACKGROUND

Extrusion is a manufacturing process used to make elongated products such as pipes, hoses, drinking straws, curtain tracks, rods, fibres, and the like. In the method, granules are melt into a liquid which is forced through a die, forming a long ‘tube like’ shape. The shape of the die determines the shape of the tube. The extrusion is then cooled and to form a solid shape. Although the process is straightforward, it is not suitable for manufacture of products of comprising complex 3D structures such as optical devices. Furthermore, the method does not allow incorporation of mechanical structures to the products during the process.

Injection moulding, in turn, is a manufacturing process for producing parts by injecting molten material into a mould. Injection moulding can be performed with a host of materials such as thermoplastic and thermosetting polymers. Material for the part is fed into a heated barrel, mixed, and injected into a mould cavity, where it cools and hardens to the configuration of the cavity. However, size of the mould defines the size of the product to be manufactured. Thus, for manufacturing elongated products by injection moulding, elongated moulds are required. Also, the size of the machinery must be increased. These, in turn increase production costs.

Accordingly, there is need for further processes for manufacture of elongated products.

### SUMMARY

It is an object of the present invention to provide a system for injection moulding of elongated products by injection moulding, the system comprising
i. a mould comprising
   at least a first part and a second part,
   a cavity comprising an open first end, second end, a first side and a second side,
ii. means for injecting material into the cavity,
iii. means for opening and closing the mould between the first part and the second part,
iv. means for opening and closing the open first end of the cavity, and
v. means for moving the elongated product on surface of the second part.

It is also an object of the present invention to provide a new method for producing elongated products by injection moulding by using the system of claim 1.

Further aspects of the present technology are described in the accompanying dependent claims.

Exemplifying and non-limiting embodiments of the invention, both as to constructions and to methods of operation, together with additional objects and advantages thereof, are best understood from the following description of specific exemplifying embodiments when read in connection with the accompanying drawings.

The verbs “to comprise” and “to include” are used in this document as open limitations that neither exclude nor require the existence of un-recited features. The features recited in the accompanied depending claims are mutually freely combinable unless otherwise explicitly stated. Furthermore, it is to be understood that the use of “a” or “an”, i.e. a singular form, throughout this document does not exclude a plurality.

### BRIEF DESCRIPTION OF DRAWINGS

Exemplifying and non-limiting embodiments and their advantages are explained in greater detail below with reference to the accompanying drawings, in which:

FIG. 1 shows a side view of a system according to an exemplary non-limiting embodiment of the present invention,

FIG. 2 shows a top view of a second part of the system of FIG. 1,

FIG. 3 shows a side view of system according to an exemplary non-limiting embodiment of the present invention,

FIG. 4 shows a top view of a second part of the system of FIG. 3, and

FIGS. 5A-E show representative operation steps of an exemplary non-limiting system of the present invention,

FIG. 6 shows an exemplary first part of an elongated product obtainable using the system of FIG. 1, and

FIG. 7 shows an exemplary elongated product obtainable using the system of FIG. 3.

### DESCRIPTION OF THE INVENTION

The specific examples provided in the description below should not be construed as limiting the scope and/or the applicability of the accompanied claims. Lists and groups of examples provided in the description are not exhaustive unless otherwise explicitly stated.

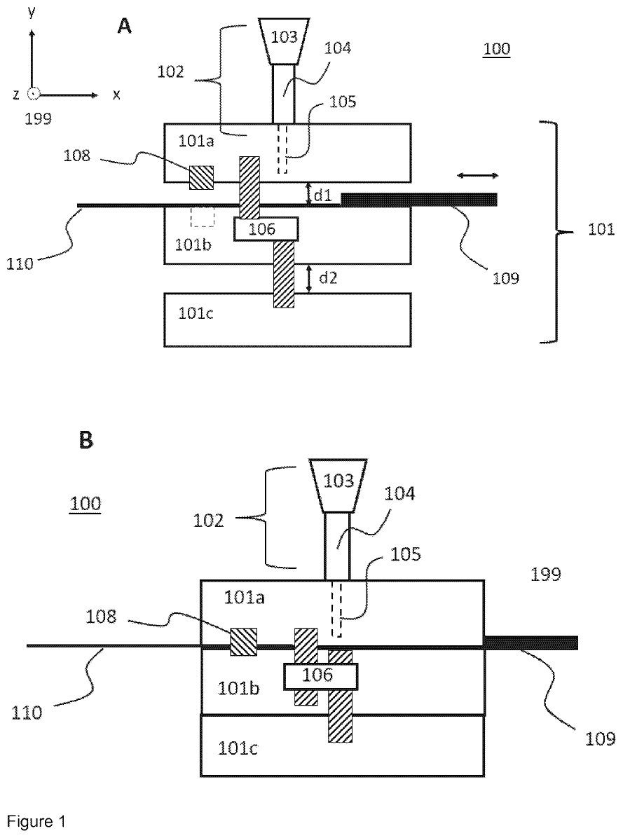

FIG. 1 shows side view of a system 100 according to an exemplary non-limiting embodiment of the present invention. The system comprises a mould 101 comprising a first part 101a, a second part 101b, and a third part 101c. In FIGS. 1A and 1B the mould is in open and closed configuration, respectively. The system comprises also means 102 for injecting the material into the mould. Typically the means 102 comprises means 103 such as a hopper for storing and feeding material such as plastic granules, means 104, such as a heater, for melting and liquefying the material, and an injection port 105 for injecting the liquefied material to a mould cavity. The system may also comprise means for cooling the mould such as water circulation system to facilitate solidifying of the injected material in the mould cavity. The injection port 105 of the system of FIG. 1 is in the first part. However, the injection port can be in other parts of the mould also.

The system comprises means 106 for opening and closing a space d1 between the first part and the second part of the mould, and also for opening and closing the space d2 between the second part and the third part of the mould i.e. moving the first part and the third part in (+/−) y-direction of the coordinate system 199. In FIGS. 1A and 1B the space d1 and d2 is open and closed, respectively. Function of the means 107-110 of the figure are discussed below.

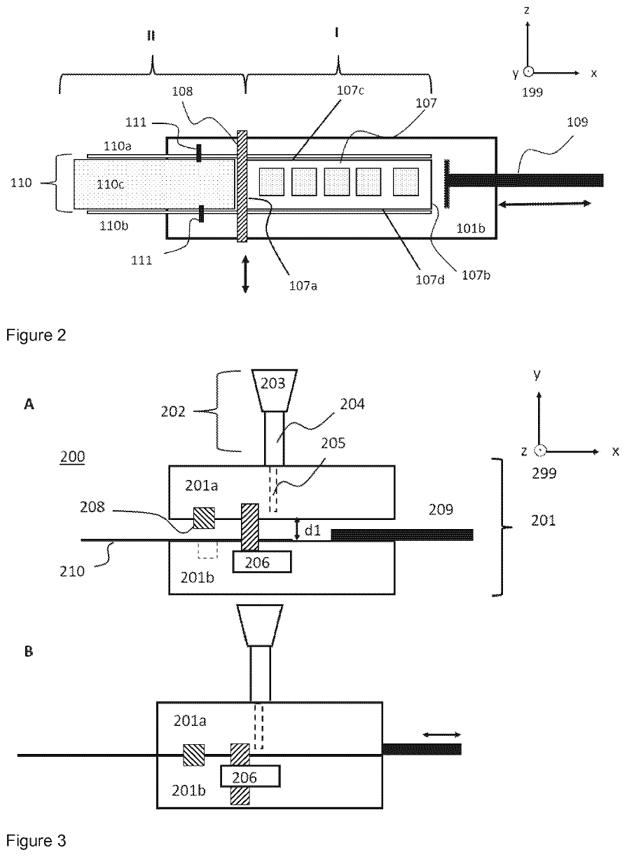

FIG. 2 shows a top view of the second part 101b of the mould of the system 100. The mould comprises a cavity 107 comprising an open first end 107a, a closed second end 107b, a first side 107c, and a second side 107d. The bottom and the top of the mould cavity are not shown in the figure. The system comprises also means 108 for opening and closing the first end of the mould cavity. The means is typically positioned at the first part of the mould as shown in FIG. 1A,B, and is configured to move in (+/−) z-direction of the coordinate system 199 for allowing the closing and the opening.

The system comprises also means 109, such as a piston, configured to move in (+/−) x-direction of the coordinate system 199. The means is for moving a part of the elongated product manufactured by the system from a first position, i.e. from the position wherein the product is injection moulded to a second position. When the part of the elongated product is at the second position, one of its ends closes the open end of the mould cavity.

According to a preferable embodiment the system comprises also means 110, for guiding movement of the product in (−) x-direction of the coordinate system 199. An exemplary system 110 is a guiding rail comprising two rails 110a, 110b parallel to the two sides of the mould cavity and a base part 110c between the rails and extending outside the mould. The guiding means also support the elongated product during the manufacturing process. The base portion must not enclose the mould cavity. As seen from FIG. 2, the base portion is between the guiding rails only outside the mould cavity.

The system comprises preferably also means 111, such as a clamp, for holding still a product at the second position during injection moulding processes. The first position and the second position of an exemplary part of an elongated product manufactured by the system is shown in the FIG. 2 by Roman numbers I and II, respectively.

FIG. 3 shows a side view of system 200 according to another exemplary non-limiting embodiment of the present invention. In contrast to system 100, the mould 201 of the system 200 has only one parting line, i.e., the mould comprises a first part 201a and a second part 201b. The system comprises also means 202 for injecting the material into the mould. Typically, the means 202 comprises a hopper 203 of the like for storing and feeding material such as plastic granules, heating means 204, for melting and liquefying the material, and an injection port 205 for injecting the liquefied material to a mould cavity. The system may also comprise means for cooling the mould such as water circulation system to facilitate solidifying of the injected material in the mould cavity. The injection port 205 of the system of FIG. 3 is in the first part. However, the injection port can be in other parts of the mould also.

The system comprises means 206 for opening and closing a space d1 between the first part and the second of the mould i.e. moving the first part in (+/−) y-direction of the coordinate system 299. In FIGS. 3A and 3B the space d1 is open and closed, respectively. Function of the means 207-210 of the figure are discussed below.

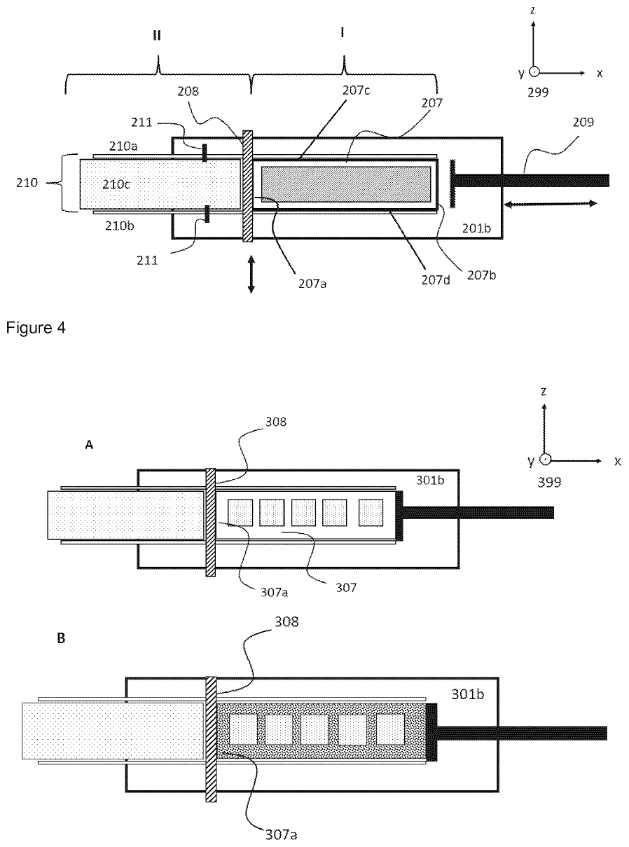

FIG. 4 shows top view of the second part 201b of a mould of the system 200. The mould comprises a cavity 207 comprising an open first end 207a, a closed second end 207b, a first side 207c, and a second side 207d. The bottom and the top of the mould cavity are not shown in the figure. The system comprises also means 208 for opening and closing the first end of the mould cavity. The means is typically positioned at the first part of the mould as shown in FIG. 3 and is configured to move in (+/−) z-direction of the coordinate system 299 for allowing the closing and the opening.

The system comprises also means 209, such as a piston, configured to move in (+/−) x-direction of the coordinate system 299. The means is configured to move a part of the elongated product manufactured by the system from a first position, i.e. from the position wherein the product is injection moulded to a second position. When the part of the elongated product is at the second position, one of its ends closes the open end of the mould cavity.

According to a preferable embodiment the system comprises also means 210, for guiding movement of the product in (−) x-direction of the coordinate system 299. An exemplary means 210 is a guiding rail comprising two rails 210a, 210b parallel to the two sides of the mould cavity and a base part 210c between the rails and extending outside the mould. The guiding means also support the elongated product during the manufacturing process. The base portion must not enclose the mould cavity. As seen from FIG. 4, the base portion is between the guiding rails only outside the mould cavity.

The system comprises preferably also means 211, such as a clamp, for holding still a product at the second position during injection moulding processes. The first position and the second position of an exemplary part of an elongated product manufactured by the system is shown in the figure by Roman numbers I and II, respectively.

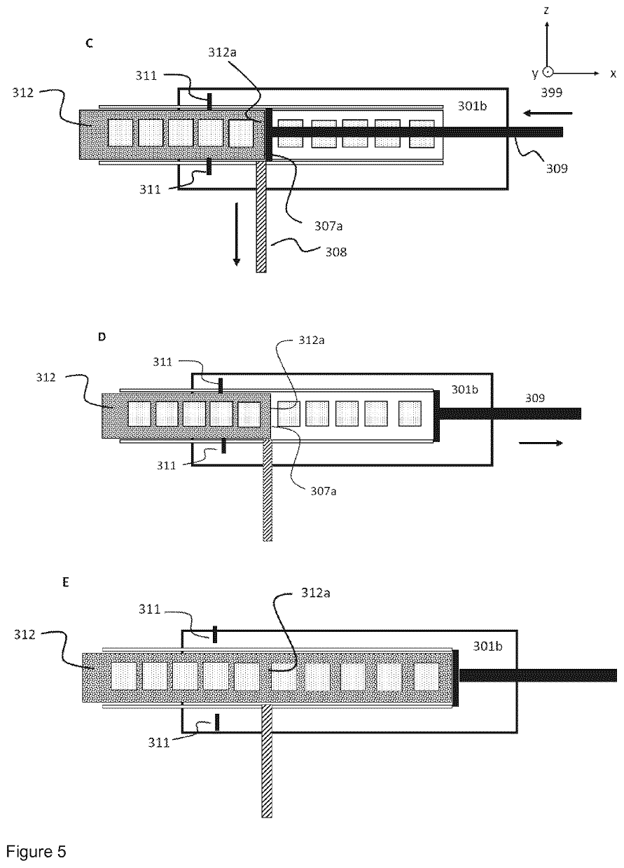

The function of the system is described in FIGS. 5A-E. Closing and opening of the mould cavity is omitted from the figures for clarity.

FIG. 5A shows a situation wherein the mould cavity 307 is empty. The open first end 307a is closed by the means 308 such as a shutter.

In FIG. 5B, the material has been injected to the mould cavity. The means 308 prevents leakage of the liquefied material from the mould via the open end. A first part of the elongated product is formed.

FIG. 5C shows a situation wherein the first part 312 of the elongated product is moved from the first position (i.e. from the position of the mould cavity) to the second position by moving the means 308 from the open end of the cavity and by moving the piston 309 in (−) x-direction of the coordinate system 399. An end 312a of the first part of the elongated product closes the open end of the mould cavity.

FIG. 5D shows a situation wherein the piston 309 is pulled back and the mould is ready for injection of the second part of the elongated product. The end 312a of the first part of the elongated product closes the open end 307a of the mould cavity. A pair of means 311 holds the part 312 still at the second position.

FIG. 5E shows a situation wherein the mould is filled with liquefied material. Since the liquefied material is in direct contact with the part of elongated product, the hot material melts the end 312a and joins it seamlessly to the material in the mould.

The present invention also concerns a method for producing an elongated product by injection moulding by using the system. The method comprises the following steps
a) closing the mould, thereby forming a closed mould cavity,
b) injecting liquefied material into the closed mould cavity,
c) allowing the liquified material to solidify, thereby forming a part 312 of the elongated product,
d) opening the mould,
e) moving the part of the elongated product on surface of the second part 301b of the mould to a position wherein an end 312a of the part of the elongated product closes open first end 307a of the mould cavity,
f) closing the mould, thereby forming a closed mould cavity,
g) injecting liquefied material into the closed mould cavity,
h) allowing the liquified material to melt material from the end 312a of the first part for joining the part of the elongated product and the material in the mould,
i) allowing the liquified material to solidify, thereby forming the elongated product, and
j) opening the mould.

Preferably the method comprises holding still the part of the elongated product between steps f) to i).

The steps e) to j) can be repeated until the desired length of the product is produced.

According to a preferable embodiment the elongated product is injection moulded using a system comprising a mould comprising two parting lines, such as the system 100 shown in FIGS. 1 and 2. According to this embodiment the method comprises the following steps
a) closing
   i. the mould 101 between
      the first part 101a and the second part 101b
      the second part 101b and the third part 101c
   ii. the first end 107a of the mould cavity,
thereby forming a closed cavity,
b) injecting liquefied material into the closed mould cavity,
c) allowing the liquified material to solidify, thereby forming a part of the elongated product,
d) opening
   i. the mould between the first part and the second part, and between the second part and the third part and
   ii. the first end of the mould cavity,
e) moving the part of the elongated product from a first position I to a second position II so that an end of the part of the elongated product closes the first end of the mould cavity,
f) closing the mould between the first part and the second part, and between the second part and the third part thereby forming a closed mould cavity,
g) injecting liquefied material into the closed mould cavity,
h) allowing the liquified material to melt material from the end of the first part for joining first part of the elongated product and the material in the mould,
i) allowing the liquified material to solidify, thereby forming the elongated product, and
j) opening the mould between the first part and the second part, and between the second part and the third part.

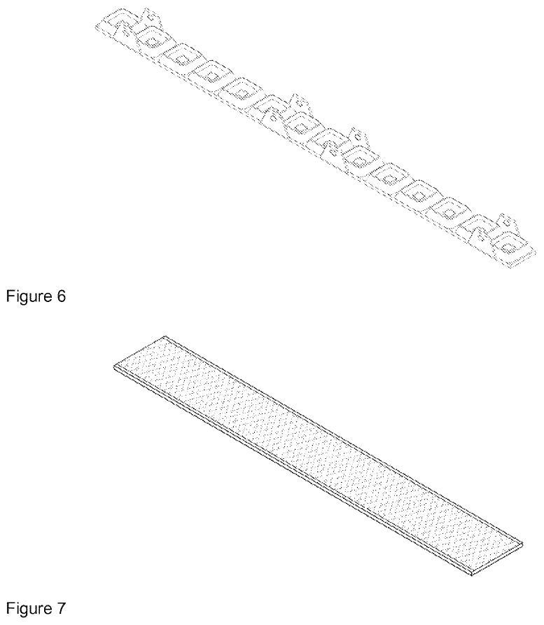

An exemplary product obtainable using a system comprising two parting lines is shown in FIG. 6.

According to another embodiment the product is injection moulded using a system comprising a mould comprising only one parting line, such as the system 200 shown in FIGS. 3 and 4. According to this embodiment the method comprises the following steps. According to one embodiment the method comprises the following steps
a) closing
   i. the mould between the first part 201a and the second part 201b
   ii. the first end 207a of the mould cavity,
thereby forming a closed cavity,
b) injecting liquefied material into the closed mould cavity,
c) allowing the liquified material to solidify, thereby forming a part of the elongated product,
d) opening
   i. the mould between the first part and the second part, and
   ii. the first end of the mould cavity,
e) moving the part of the elongated product from a first position I to a second position II so that an end of the part of the elongated product closes the first end of the mould cavity,
f) closing the mould between the first part and the second thereby forming a closed mould cavity,
g) injecting liquefied material into the closed mould cavity,
h) allowing the liquified material to melt material from the end of the first part for joining first part of the elongated product and the material in the mould,
i) allowing the liquified material to solidify, thereby forming the elongated product, and
j) opening the mould between the first part and the second part.

An exemplary product obtainable using a system comprising only one parting line is shown in FIG. 7.

The injection moulding of the present invention can be performed with materials suitable for injection moulding known in the art. Exemplary materials include metals, glasses, elastomers, thermoplastic polymers, and thermosetting polymers. A particular material is optical grade material such as optical grade PMMA, optical grade PDMS, optical grade polycarbonate and optical grade silicone.

The advantages of the present invention can be summarized as follows
The technology can be used produce high precision products.
Long, dimensionally accurate products can be produced with a substantially small machine.
When the mould opens not only between the first part and the second part, but also between the second part and the third part, the system allows manufacture of complicated products such as optical devices with optics on both surfaces.
The technology is also suitable for the manufacture products that require mechanics.

1. A system (100, 200) for injection moulding an elongated product, the system comprising
i. a mould (101, 201) comprising
at least a first part (101a, 201a) and a second part (101b, 201b),
a cavity comprising an open first end (107a, 207b), second end (107b, 207b), a first side (107c, 207c) and a second side (107d, 207d),
ii. means (102, 202) for injecting material into the cavity,
iii. means (106, 206) for opening and closing the mould between the first part and the second part,
iv. means (108, 208) for opening and closing the open first end of the cavity, and
v. means (109, 209) for moving the elongated product on surface of the second part.

2. The system (100) according to claim 1 wherein the mould (101) comprises a third part (101c), and the means (106) is configured to open and close the mould between
the first part (101a) and the second part (101b), and
the second part (101b) and the third part (101c).

3. The system according to claim 1 comprising means (110, 210) for guiding the moving.

4. The system according claim 3 wherein the means (110, 210) comprises a first rail (110a, 210a) and a second rail (110b, 210b) positioned on the surface of the second part and parallel to the first side and the second side of the mould cavity.

5. The system according to claim 4 wherein the means (110, 210) comprises a base (110c, 210c) between the first rail and the second rail, provided that the base does not enclose the mould cavity.

6. The system according to claim 1 wherein the system comprises means (111, 211) for holding still the elongated product.

7. The system according to claim 1 wherein the means (102, 202) comprises a hopper (103, 203) for storing and feeding the material, a heater (104, 204), and an injection port (105, 205) connected to the cavity.

8. A method for producing an elongated product by injection moulding using the system according to claim 1, the method comprising the following steps
a) closing a mould thereby forming a closed mould cavity,
b) injecting liquefied material into the closed mould cavity,
c) allowing the liquified material to solidify, thereby forming a part of the elongated product,
d) opening the mould,
e) moving the part of the elongated product on surface of a second part of the mould to a position wherein an end of the part of the elongated product closes open first end of the mould cavity,
f) closing the mould,
g) injecting liquefied material into the closed mould cavity,
h) allowing the liquified material to melt material from the end of the first part for joining the part of the elongated product and the material in the mould,
i) allowing the liquified material to solidify, thereby forming the elongated product, and
j) opening the mould.

9. The method according to claim 8 comprising holding still the part of the elongated product between steps f) to i).

10. The method according to claim 8 comprising repeating steps e) to j).

11. The method according to claim 8 wherein the material is selected from a group consisting of metals, glasses, elastomers, thermoplastic polymers, and thermosetting polymers, preferably from thermoplastic polymers and thermosetting polymers.

12. The method according to claim 8, wherein the material is optical grade material preferably selected from a group consisting of optical grade PMMA, optical grade PDMS, optical grade polycarbonate and optical grade silicone.

13. The method according to claim 8 wherein the elongated product is an optical device.
